(19) United States
(12) Patent Application Publication
(10) Pub. No.: US 2019/0061725 A1
(43) Pub. Date: Feb. 28, 2019

(54) Parking Brake Cable Stretch Assist Tool

(71) Applicant: Nissan North America, Inc., Franklin, TN (US)

(72) Inventor: Robert Muccioli, Royal Oak, MI (US)

(21) Appl. No.: 15/693,130

(22) Filed: Aug. 31, 2017

(51) Int. Cl. B60T 11/04; B60T 7/04

(52) U.S. Cl. CPC B60T 11/046; B60Y 2304/07; B60T 7/04

(57) ABSTRACT

A calibrated adjustable-configuration parking brake stretching assist tool comprising a handle, a brake pedal engagement portion attached to a first end of the handle, such that the handle extends along an axis to a second end of the handle, the brake pedal engagement portion for depressing a parking brake control assembly of a vehicle in response to a force applied to the second end of the handle, and an actuation control portion, laterally attached to the calibrated adjustable-configuration parking brake stretching assist tool proximate to the first end of the handle, for engaging a fixed portion of the vehicle adjacent to the parking brake control assembly on a condition that the parking brake control assembly is depressed by a defined depression amount.

### TECHNICAL FIELD

This disclosure relates to parking brake systems, including an apparatus for stretching a parking brake cable.

### BACKGROUND

During the installation of a parking brake in a vehicle at a manufacturing plant, the parking brake cable may be stretched (lapped) to ensure effective hill hold and prevent the cable from stretching in the market. Accordingly, in order to stretch the parking brake cable correctly, the parking brake pedal must be depressed to a defined level, such as a full pedal stroke, a three-quarter pedal stroke, or by a defined force, for a defined period, such as at least thirty minutes. The parking brake cable may be stretched, such as during vehicle manufacture, by a technician manually applying force depressing the parking brake pedal, which may include using an assist tool, by the defined amount.

The depression of the parking brake pedal by hand or tool may not result in the pedal being depressed the appropriate amount for the appropriate amount of time. Currently, there are no assist tools that confirm that the parking brake pedal has been depressed the required amount. Likewise, a technician is not made aware that the appropriate depression level has been reached when done by hand. Therefore, there exists a need for an improved assist tool.

### SUMMARY

Disclosed herein are implementations of a parking brake stretching assist tool for depressing a parking brake pedal by a defined amount for accurate parking brake cable stretching.

An aspect of the disclosed embodiments is a calibrated adjustable-configuration parking brake stretching assist tool comprising a handle, a brake pedal engagement portion attached to a first end of the handle, such that the handle extends along an axis to a second end of the handle, the brake pedal engagement portion for depressing a parking brake control assembly of a vehicle in response to a force applied to the second end of the handle, and an actuation control portion, laterally attached to the calibrated adjustable-configuration parking brake stretching assist tool proximate to the first end of the handle, for engaging a fixed portion of the vehicle adjacent to the parking brake control assembly on a condition that the parking brake control assembly is depressed by a defined depression amount.

Another aspect of the disclosed embodiments is a method for stretching a parking brake cable. The method for stretching the parking brake cable includes engaging at least a portion of a parking brake control assembly of a vehicle with a calibrated adjustable-configuration parking brake stretching assist tool in a neutral position, wherein the parking brake control assembly includes a parking brake cable. The calibrated adjustable-configuration parking brake stretching assist tool includes a handle, a parking brake control assembly engagement portion attached to a first end of the handle, such that the handle extends along an axis to a second end of the handle, and an actuation control portion, laterally attached to the calibrated adjustable-configuration parking brake stretching assist tool proximate to the first end of the handle. The method for stretching the parking brake cable includes applying a force to the handle such that the actuation control portion contacts a fixed surface of the vehicle indicating that the portion of the parking brake control assembly is depressed by a defined depression amount.

Another aspect of the disclosed embodiments is a calibrated adjustable-configuration parking brake stretching assist tool comprising a handle, a brake pedal engagement portion attached to a first end of the handle, such that the handle extends along an axis to a second end of the handle, the brake pedal engagement portion for depressing a parking brake control assembly of a vehicle in response to a force applied to the second end of the handle, and an actuation control portion, laterally attached to the calibrated adjustable-configuration parking brake stretching assist tool proximate to the first end of the handle, for engaging a fixed portion of the vehicle adjacent to the parking brake control assembly on a condition that the parking brake control assembly is depressed by a defined depression amount, wherein the actuation control portion includes an actuation detection unit, and wherein, in response to detecting that the parking brake control assembly is depressed by the defined depression amount, the actuation detection unit outputs an indication that the parking brake control assembly is depressed by the defined depression amount.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a perspective view of an example of an uncalibrated fixed-configuration parking brake stretching assist tool in accordance with this disclosure.

FIG. 2 is a perspective view of an example of a calibrated adjustable-configuration parking brake stretching assist tool in accordance with implementations of this disclosure.

FIG. 3 is a side view of an example of the calibrated adjustable-configuration parking brake stretching assist tool shown in FIG. 2 in accordance with implementations of this disclosure.

FIG. 4 is a side view of another example of a calibrated adjustable-configuration parking brake stretching assist tool in an un-actuated position in accordance with implementations of this disclosure.

FIG. 5 is a side view of the example of the calibrated adjustable-configuration parking brake stretching assist tool shown in FIG. 4 in a stretching position in accordance with implementations of this disclosure.

FIG. 6 is a front perspective view of another example of a calibrated adjustable-configuration parking brake stretching assist tool in an un-actuated position in accordance with implementations of this disclosure.

FIG. 7 is a front perspective view of the example of the calibrated adjustable-configuration parking brake stretching assist tool shown in FIG. 6 in a stretching position in accordance with implementations of this disclosure.

### DETAILED DESCRIPTION

A vehicle may include a locking brake system, such as a parking brake, to prevent or resist vehicle motion, maintain a stationary orientation of the vehicle, or the like. The parking brake may include a parking brake control assembly, for actuating the parking brake in response to an actuating force; a braking assembly, for applying a braking force to the vehicle; and a parking brake cable for connecting the parking brake control assembly to the braking assembly and for transmitting the actuating force from the parking brake control assembly to the braking assembly. The parking brake cable may be installed in the vehicle, operatively connecting the parking brake control assembly to the braking assembly at a defined tension, which may be a tension within a defined parking brake cable tension range.

Subsequent to installation in the vehicle, the parking brake cable may stretch, such as inelastically stretch (structural or permanent stretch), in response to the application of actuating force applied to the parking brake. Stretching of the parking brake cable subsequent to vehicle manufacture may reduce cable tension and may impair braking. Stretching of the installed parking brake cable subsequent to vehicle manufacture may be effectively prevented by stretching the installed parking brake cable (in situ or in vehicle condition) during vehicle manufacture.

Stretching the parking brake cable in vehicle conditions (in situ) may include applying a stretching force to the parking brake cable such as by applying an actuating force to the parking brake control assembly. For example, the parking brake control assembly may include a parking brake control arm or lever, a parking brake pedal, or both, and applying an actuating force to the parking brake control assembly may include depressing the parking brake pedal.

To optimize parking brake cable stretching, which may include stretching the parking brake cable during vehicle manufacture such that subsequent stretching, such as inelastic stretching, of the parking brake cable during vehicle use (subsequent to vehicle manufacture) is eliminated or limited to within a defined maximum threshold, the parking brake cable may be stretched by a defined amount, such as with a defined amount of force, such as 490N F (Newton Force), for a defined temporal period. For example, the parking brake control assembly may include a parking brake control arm or lever, a parking brake pedal, or both, and applying an actuating force to the parking brake control assembly may include depressing the parking brake control arm or the parking brake pedal, by depressing the parking brake control arm or the parking brake pedal by a defined amount or distance, such as by a full stroke, or by a three-quarter stroke (three-quarters full pedal stroke), for a defined period, such as thirty minutes. Any defined amount or distance of depression and any defined period may be used.

A human technician may stretch an installed parking brake cable (in situ) during vehicle manufacture by manually depressing the parking brake parking brake pedal by an approximation of the defined amount. Accurate information indicating the accuracy of the approximation of the amount of depression or force may be unavailable, and the parking brake cable may be stretched inaccurately. To improve the accuracy and efficiency of parking brake stretching, the technician may use a parking brake stretching assist tool.

A parking brake stretching assist tool may interface or engage with a portion of the parking brake control assembly, such as the parking brake control arm or lever, the parking brake pedal, or both, and may improve the accuracy, efficiency, or both, of parking brake cable stretching, and which may include improving technician health, safety, comfort, or a combination thereof.

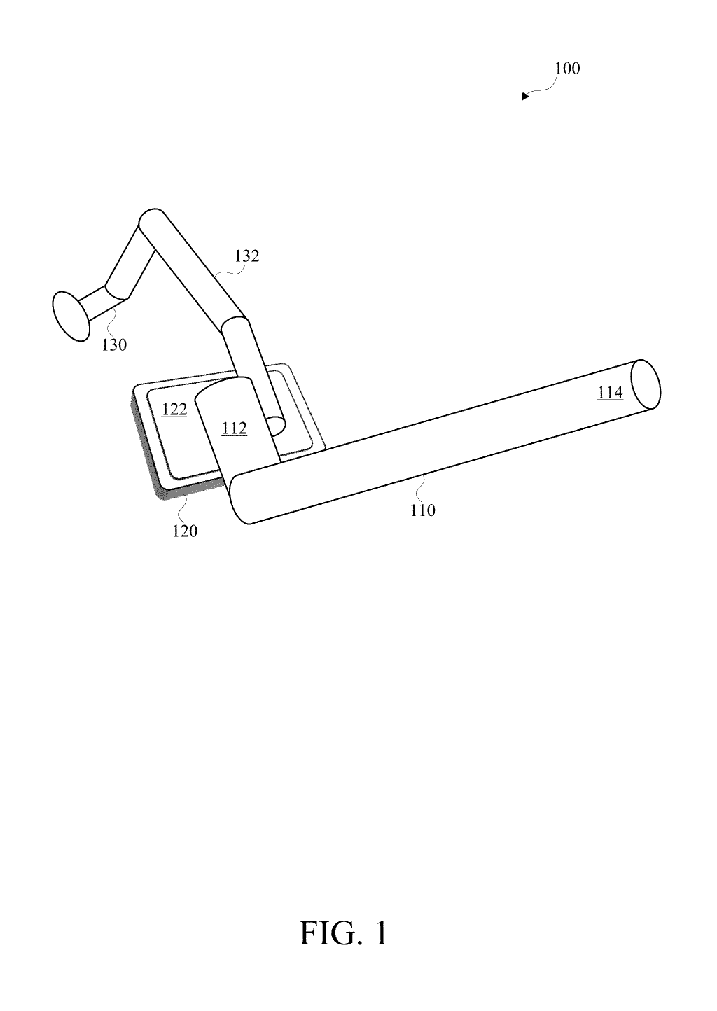

FIG. 1 is a perspective view of an example of an uncalibrated fixed-configuration parking brake stretching assist tool 100 in accordance with this disclosure. The uncalibrated fixed-configuration parking brake stretching assist tool 100 comprises a handle 110, a brake pedal engagement portion 120, and a parking brake control arm engagement portion 130. The uncalibrated fixed-configuration parking brake stretching assist tool 100 may be used by a technician to stretch a parking brake cable (not shown) installed in a vehicle (not shown).

For example, a parking brake (not shown) installed in the vehicle (not shown) may include a parking brake control assembly (not shown), a braking assembly (not shown), and a parking brake cable (not shown) connecting the parking brake control assembly (not shown) to the braking assembly (not shown), and a technician may use the uncalibrated fixed-configuration parking brake stretching assist tool 100 to interface with, engage, actuate, or depress the parking brake control assembly (not shown), or a portion thereof, during vehicle manufacture or assembly (in situ).

The brake pedal engagement portion 120 may have a proximate surface 122 and a distal surface (not shown) opposite the proximate surface 122. The parking brake control assembly (not shown) may include a parking brake control arm or lever (not shown) and a parking brake pedal (not shown). The distal surface of the brake pedal engagement portion 120 may engage with a proximate surface (not shown) of the parking brake pedal (not shown). The parking brake may include other elements that are not shown for clarity, such as an adjustment nut, which may adjust the tension on the parking brake cable, and a mounting bracket for mounting the parking brake to the vehicle.

The parking brake control arm engagement portion 130 may engage with a distal portion (not shown) of the parking brake control arm (not shown). The parking brake control arm engagement portion 130 may be fixedly connected or attached to the brake pedal engagement portion 120 via a support bar 132, such that a force, or a portion thereof, applied to the brake pedal engagement portion 120, to depress the brake pedal (not shown), in a first direction, such as downward or toward a floor of the vehicle (not shown), may be rotationally translated or communicated to the parking brake control arm engagement portion 130, such that the parking brake control arm engagement portion 130 applies a corresponding force to the distal surface of the parking brake control arm (not shown) in a second direction, such as upward, opposite the first direction, which may secure the uncalibrated fixed-configuration parking brake stretching assist tool 100 to the parking brake control assembly (not shown).

The handle 110 may be fixedly connected or attached to the brake pedal engagement portion 120 at a first end 112 of the handle 110, and may extend, away from the parking brake control assembly (not shown) to a second end 114 of the handle 110, such that a force, such as an actuating force, applied to the handle 110, such as proximate to the second end 114, may be translated to or communicated to the brake pedal engagement portion 120 to depress or actuate the parking brake control assembly (not shown).

The configuration of the uncalibrated fixed-configuration parking brake stretching assist tool 100 shown in FIG. 1 is an example. Other configurations may be used. For example, the parking brake control assembly may omit a parking brake pedal, and the uncalibrated fixed-configuration parking brake stretching assist tool may omit the brake pedal engagement portion 120 and may include a second parking brake control arm engagement portion for engaging with a proximate surface of the parking brake control arm.

A technician may stretch the installed parking brake cable (in situ) during vehicle manufacture or assembly by depressing the parking brake parking brake pedal by an approximation of the defined amount using the uncalibrated fixed-configuration parking brake stretching assist tool 100 shown in FIG. 1. Accurate information indicating the accuracy of the approximation of the amount of depression or force may be unavailable, and the parking brake cable may be stretched inaccurately.

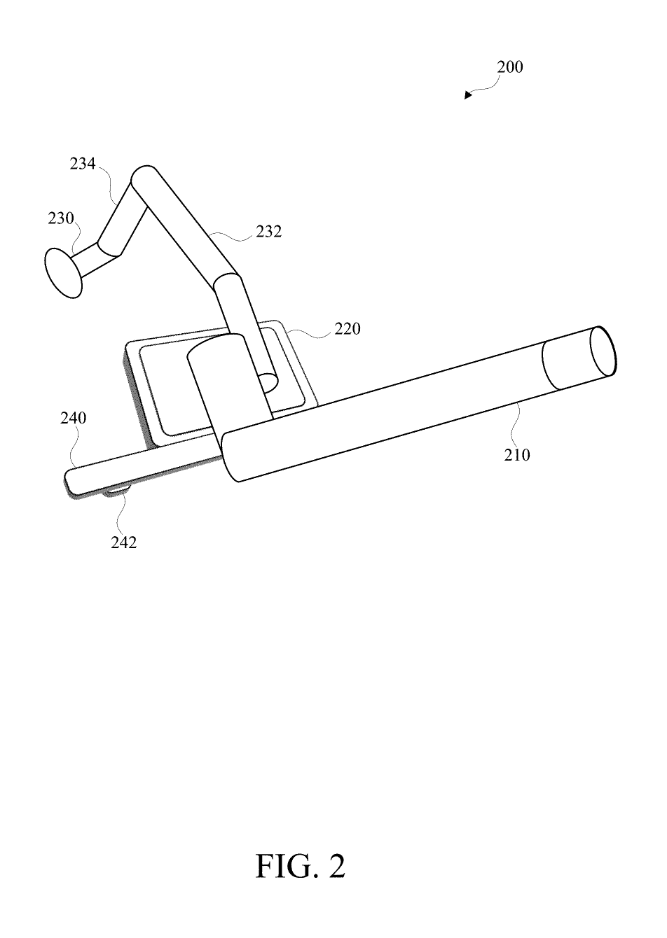

FIG. 2 is a perspective view of an example of a calibrated adjustable-configuration parking brake stretching assist tool 200 in accordance with implementations of this disclosure. The calibrated adjustable-configuration parking brake stretching assist tool 200 shown in FIG. 2 may be similar to the uncalibrated fixed-configuration parking brake stretching assist tool 100 shown in FIG. 1, except as described herein or otherwise clear from context.

The calibrated adjustable-configuration parking brake stretching assist tool 200 comprises a handle 210, a brake pedal engagement portion 220, a parking brake control arm engagement portion 230, and an actuation control portion 240. The calibrated adjustable-configuration parking brake stretching assist tool 200 may be used by a technician to stretch a parking brake cable (not shown) installed in a vehicle (not shown), which may improve the accuracy, efficiency, or both, of parking brake cable stretching relative to parking brake cable stretching using the uncalibrated fixed-configuration parking brake stretching assist tool 100 shown in FIG. 1, which may reduce or eliminate inadvertent parking brake cable stretching error, and which may improve technician health, safety, comfort, or a combination thereof.

The parking brake control arm engagement portion 230 may be fixedly connected or attached to the brake pedal engagement portion 220 via a support bar 232 in a fixed configuration as shown, or may be adjustably connected or attached to the brake pedal engagement portion 220 via an adjustable support bar (not expressly shown). For example, the parking brake control arm engagement portion 230 may connect to the support bar 232 via an adjustable support member 234, such that the parking brake control arm engagement portion 230 may rotate, such as 180 degrees, around a longitudinal axis of the adjustable support member 234 and may be locked in one of two or more positions. Other lockable adjustable elements for controlling or adjusting the relative orientation of the parking brake control arm engagement portion 230 may be used. For example, one or more of a length of the parking brake control arm engagement portion 230, an angle of the parking brake control arm engagement portion 230, a length of the support bar 232, or a length of the support member 234, may be fixed or adjustable.

The actuation control portion 240 may be adjustably connected or attached to the brake pedal engagement portion 220, and may extend, away from the parking brake control assembly (not shown), at an angle and for a distance (adjusted length) such that a distal surface (not shown) of the actuation control portion 240 may contact or engage with a proximal surface of a fixed element of the vehicle, such as a floor of the vehicle or a foot-rest component of the floor of the vehicle, concurrent with depressing the parking brake control assembly, or a portion thereof, by the defined amount, which may prevent depressing or actuating the parking brake control assembly by an amount exceeding or greater than the defined amount. For example, the actuation control portion 240 may extend longitudinally from a portion of the calibrated adjustable-configuration parking brake stretching assist tool 200 proximate to the first end of the handle 210 for a defined length of longitudinal extension.

In some embodiments, the actuation control portion 240 may be fixedly connected or attached to the brake pedal engagement portion 220 or may be adjustably or fixedly connected or attached to the handle 210. The actuation control portion 240 may extend parallel to the brake pedal engagement portion 220 as shown, perpendicular to the brake pedal engagement portion 220, such as toward the floor of the vehicle, (not shown), or both.

The configuration of the calibrated adjustable-configuration parking brake stretching assist tool 200 shown in FIG. 2 is an example. Other configurations may be used. For example, the parking brake control assembly may omit a parking brake pedal, the uncalibrated fixed-configuration parking brake stretching assist tool may omit the brake pedal engagement portion 220 and may include a second parking brake control arm engagement portion for engaging with a proximate surface of the parking brake control arm.

A technician may stretch the installed parking brake cable (in situ) during vehicle manufacture or assembly by depressing the parking brake pedal by the defined amount using the calibrated adjustable-configuration parking brake stretching assist tool 200 shown in FIG. 2. In response to depressing the parking brake pedal (not shown), such as by applying an actuating force to the calibrated adjustable-configuration parking brake stretching assist tool 200, the actuation control portion 240 may contact or engage with a proximal surface of a fixed element of the vehicle, such as a floor of the vehicle or a foot-rest component of the floor of the vehicle, which may indicate that the parking brake control assembly is depressed or actuated by the defined amount. Contact between the actuation control portion 240 and the proximal surface of the fixed element of the vehicle may indicate that the parking brake control assembly is depressed or actuated by the defined amount in the absence of information indicating a direct measurement of the magnitude of the actuating force.

In some embodiments, the actuation control portion 240 may include an actuation detection unit 242, which may extend from a distal surface of the actuation control portion 240. The actuation detection unit 242 output an indication, such as a wired or wireless electronic communication signal, in response to the actuation control portion 240 contacting or engaging with a proximal surface of a fixed element of the vehicle, such as a floor of the vehicle or a foot-rest component of the floor of the vehicle, that the parking brake control assembly is depressed or actuated by the defined amount. For example, the actuation detection unit 242 may include a spring loaded button, circuit, or switch. The indication that the parking brake control assembly is depressed or actuated by the defined amount may be sent, transmitted, or otherwise communicated to an external device, such as a computer or other receiving device.

The information output by the actuation detection unit 242 may be recorded or stored, such as in a memory of the computer. Storing the information output by the actuation detection unit 242 may include storing other information in association with the information output by the actuation detection unit 242. For example, the information output by the actuation detection unit 242 may be stored in association with temporal information, information identifying the vehicle, information identifying the technician, or any other information relevant to stretching the parking brake cable. In another example, an external device or system, such as an assembly line controller, may detect or receive the information output by the actuation detection unit 242, or may detect the omission or interruption of expected information from the actuation detection unit 242. For example, an assembly line controller may stop an assembly line for manufacturing the vehicle in response to a determination that expected information output by the actuation detection unit 242 is unavailable indicating that the calibrated adjustable-configuration parking brake stretching assist tool 200 is unengaged or improperly engaged. The calibrated adjustable-configuration parking brake stretching assist tool 200 may subsequently be properly engaged, the actuation detection unit 242 may output information indicating that the calibrated adjustable-configuration parking brake stretching assist tool 200 is properly engaged, and, in response to receiving the information indicating that the calibrated adjustable-configuration parking brake stretching assist tool 200 is properly engaged, the assembly line controller may control the assembly line to advance.

In some embodiments, a secondary indication, such as an audible indication, a visual indication, or both, may be presented in response to or concurrent with the information output by the actuation detection unit 242, which may indicate, such as to the technician, that the parking brake control assembly is depressed or actuated by the defined amount.

Stretching the parking brake cable using the calibrated adjustable-configuration parking brake stretching assist tool 200 may include adjusting the calibrated adjustable-configuration parking brake stretching assist tool 200. For example, the actuation control portion 240 may be adjustable to multiple configurations or positions. Each position or configuration of the actuation control portion 240 may correspond with actuating or depressing a respective parking brake control assembly, or a portion thereof, by a defined amount or distance to stretch a connected parking brake cable by a corresponding defined amount.

Adjusting the calibrated adjustable-configuration parking brake stretching assist tool 200 may include adjusting the calibrated adjustable-configuration parking brake stretching assist tool 200 based on one or more defined adjustment parameters, such as defined adjustment parameters associated with the vehicle. For example, the amount of actuation for stretching a parking brake cable installed in a first type or model of vehicle may correspond with a first configuration, setting, or adjustment position of the actuation control portion 240 and the amount of actuation for stretching a parking brake cable installed in a second type or model of vehicle may correspond with a second configuration, setting, or adjustment position of the actuation control portion 240.

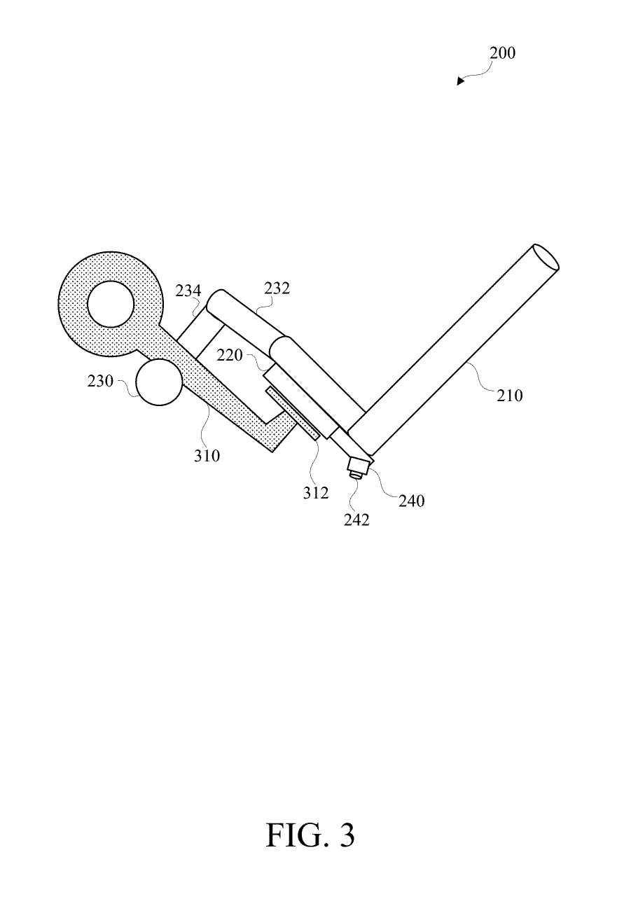

FIG. 3 is a side view of an example of the calibrated adjustable-configuration parking brake stretching assist tool 200 shown in FIG. 2 in accordance with implementations of this disclosure. In FIG. 3, a portion of a parking brake control assembly including a parking brake control arm 310 and a parking brake pedal 312 is shown for context, as indicated by the stippled background.

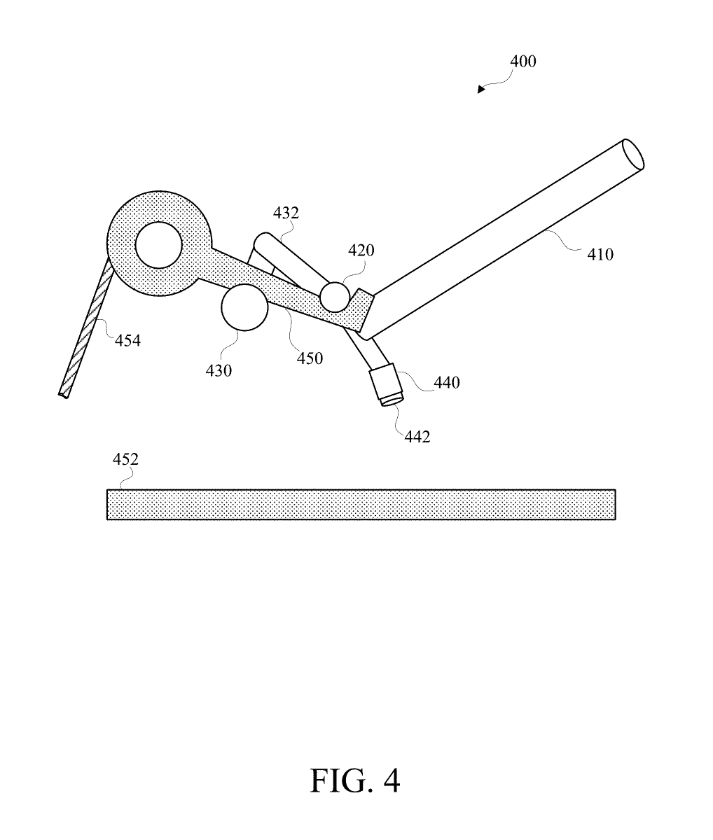

FIG. 4 is a side view of another example of a calibrated adjustable-configuration parking brake stretching assist tool 400 in an un-actuated position in accordance with implementations of this disclosure. The calibrated adjustable-configuration parking brake stretching assist tool 400 shown in FIG. 4 may be similar to the calibrated adjustable-configuration parking brake stretching assist tool 200 shown in FIG. 2, except as described herein or otherwise clear from context.

The calibrated adjustable-configuration parking brake stretching assist tool 400 comprises a handle 410, proximal parking brake control arm engagement portion 420, a distal parking brake control arm engagement portion 430, and an actuation control portion 440. The calibrated adjustable-configuration parking brake stretching assist tool 400 omits the brake pedal engagement portion 220 shown in FIG. 2.

In FIG. 4, a portion of a parking brake control assembly including a parking brake control arm 450 and omitting a parking brake pedal, and a portion of a fixed portion of the vehicle 452, such as a vehicle floor, are shown for context, as indicated by the stippled background. A representation of a parking brake cable 454 in an unstretched state is also shown for context, as indicated by the striped background.

The distal parking brake control arm engagement portion 430 may be fixedly connected or attached to the proximal parking brake control arm engagement portion 420 via a support bar 432 in a fixed configuration as shown, or may be adjustably connected or attached to the proximal parking brake control arm engagement portion 420 via an adjustable support bar (not expressly shown).

The actuation control portion 440 may be adjustably connected or attached to the proximal parking brake control arm engagement portion 420 and may extend toward a fixed portion of the vehicle, such as the fixed portion of the vehicle 452. The actuation control portion 440 may include an actuation detection unit 442, which may extend from the actuation control portion 440.

The calibrated adjustable-configuration parking brake stretching assist tool 400 is shown in FIG. 4 in an un-actuated or neutral position. The calibrated adjustable-configuration parking brake stretching assist tool 400 is shown as interfacing with, engaged with, or in contact with, the parking brake control arm 450. The actuation detection unit 442 is shown in a disengaged, unpressed state indicating that depression of the parking brake control arm 450 by the defined depression amount is undetected.

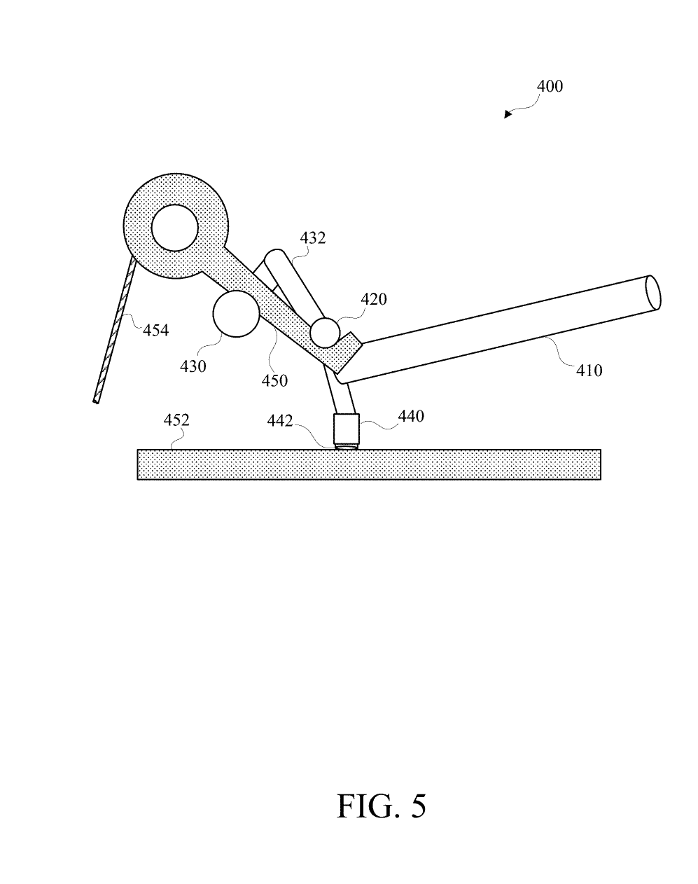

FIG. 5 is a side view of the example of the calibrated adjustable-configuration parking brake stretching assist tool 400 in a stretching position in accordance with implementations of this disclosure. In FIG. 5, the calibrated adjustable-configuration parking brake stretching assist tool 400 is shown in an actuated or stretching position, indicating that the calibrated adjustable-configuration parking brake stretching assist tool 400 is interfacing with, engaged with, or in contact with, the parking brake control arm 450, and is depressing the parking brake control arm 450 by the defined amount or distance, such as by a full stroke, or by a three-quarter stroke, such that a stretching force is applied to the parking brake cable 454. The actuation detection unit 442 is in contact with a proximal surface of the fixed portion of the vehicle 452 and is in an engaged, pressed state indicating the depression of the parking brake control arm 450 by the defined depression amount is detected. The representation of the parking brake cable 454 is shown in a stretched state.

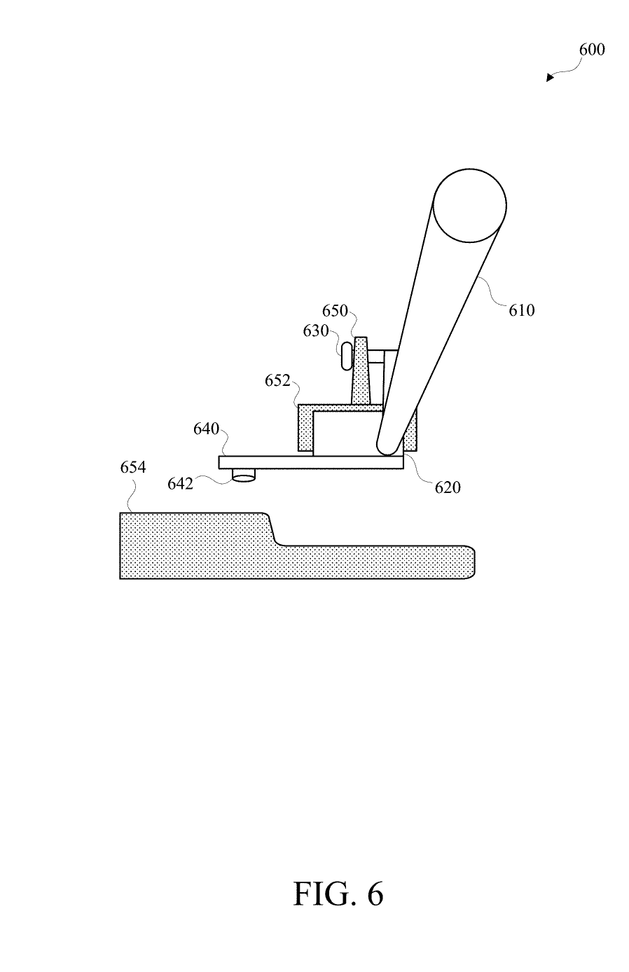

FIG. 6 is a front perspective view of another example of a calibrated adjustable-configuration parking brake stretching assist tool 600 in an un-actuated position in accordance with implementations of this disclosure. The calibrated adjustable-configuration parking brake stretching assist tool 600 shown in FIG. 6 may be similar to the calibrated adjustable-configuration parking brake stretching assist tool 200 shown in FIG. 2, except as described herein or otherwise clear from context.

The calibrated adjustable-configuration parking brake stretching assist tool 600 comprises a handle 610, a brake pedal engagement portion 620, a parking brake control arm engagement portion 630, and an actuation control portion 640. A portion of a parking brake control assembly including a parking brake control arm 650 and a parking brake pedal 652, and a portion of a fixed portion of the vehicle 654, such as a vehicle floor including a foot rest portion, are shown for context, as indicated by the stippled background.

The calibrated adjustable-configuration parking brake stretching assist tool 600 is shown in FIG. 6 in an un-actuated position. The calibrated adjustable-configuration parking brake stretching assist tool 600 is engaged with, or in contact with, the parking brake control arm 650. The actuation detection unit 642 is in a disengaged, unpressed state indicating that depression of the parking brake control arm 650 by the defined depression amount is undetected.

As an example of lockable adjustable elements for controlling or adjusting the calibrated adjustable-configuration parking brake stretching assist tool 600, the actuation control portion 640 may be adjustable, such as extendable horizontally (relative to the orientation shown) away from the parking brake 652, vertically (relative to the orientation shown) towards the floor of the vehicle 654, or both.

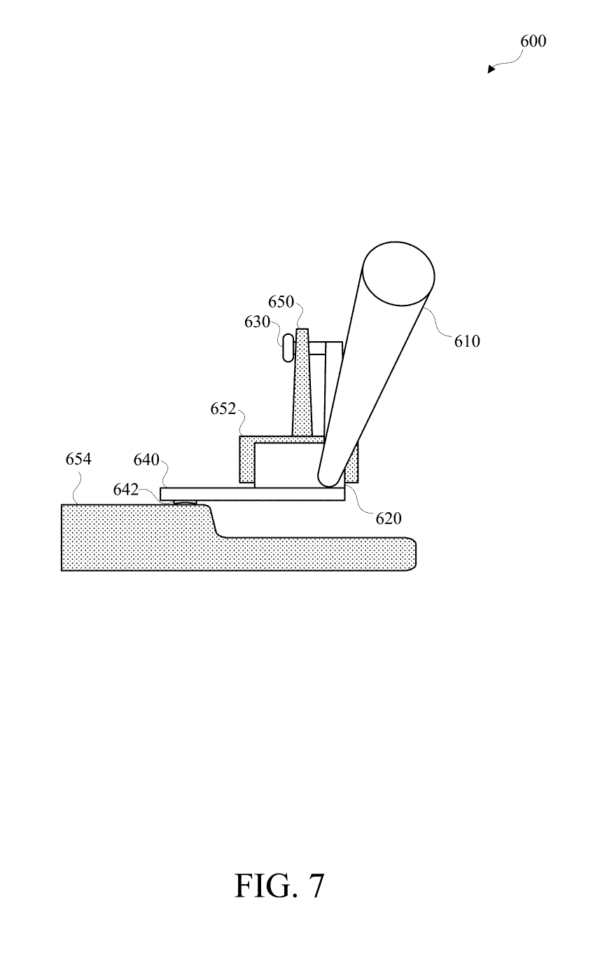

FIG. 7 is a front perspective view of the example of the calibrated adjustable-configuration parking brake stretching assist tool 600 in a stretching position in accordance with implementations of this disclosure. In FIG. 7, the calibrated adjustable-configuration parking brake stretching assist tool 600 is shown in an actuated or stretching position, indicating that the calibrated adjustable-configuration parking brake stretching assist tool 600 is engaged with, or in contact with, the parking brake control arm 650, and is depressing the parking brake control arm 650 by the defined amount or distance, such as by a full stroke, or by a three-quarter stroke. The actuation detection unit 642 is in contact with a proximal surface of the foot rest portion of the fixed portion of the vehicle 654 and is in an engaged, pressed state indicating the depression of the parking brake control arm 650 by the defined depression amount is detected.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A calibrated adjustable-configuration parking brake stretching assist tool comprising:
a handle;
a brake pedal engagement portion attached to a first end of the handle, such that the handle extends along an axis to a second end of the handle, the brake pedal engagement portion for depressing a parking brake control assembly of a vehicle in response to a force applied to the second end of the handle; and
an actuation control portion, laterally attached to the calibrated adjustable-configuration parking brake stretching assist tool proximate to the first end of the handle, for engaging a fixed portion of the vehicle adjacent to the parking brake control assembly on a condition that the parking brake control assembly is depressed by a defined depression amount.

2. The calibrated adjustable-configuration parking brake stretching assist tool of claim 1, wherein the actuation control portion includes an actuation detection unit, wherein, in response to detecting that the parking brake control assembly is depressed by the defined depression amount, the actuation detection unit outputs an indication that the parking brake control assembly is depressed by the defined depression amount.

3. The calibrated adjustable-configuration parking brake stretching assist tool of claim 2, wherein the actuation control portion has a defined length of longitudinal extension from the first end of the handle.

4. The calibrated adjustable-configuration parking brake stretching assist tool of claim 3, wherein:
the defined length of the actuation control portion is adjustable; and
the actuation control portion is extended to an adjusted length to engage the fixed portion of the vehicle on a condition that the parking brake control assembly is depressed by the defined depression amount.

5. The calibrated adjustable-configuration parking brake stretching assist tool of claim 4, wherein the defined depression amount is full pedal stroke.

6. The calibrated adjustable-configuration parking brake stretching assist tool of claim 4, wherein the defined depression amount is at least three-quarters full pedal stroke.

7. The calibrated adjustable-configuration parking brake stretching assist tool of claim 4, further comprising:
a support bar attached to the brake pedal engagement portion, and extending laterally therefrom; and
a parking brake control arm engagement portion attached to the support bar, such that the force applied to the second end of the handle is applied to a proximal surface of the parking brake control assembly in a first direction and is rotationally translated to the parking brake control arm engagement portion, such that the parking brake control arm engagement portion applies a corresponding force to a distal surface of the parking brake control arm in a second direction opposite the first direction to secure the calibrated adjustable-configuration parking brake stretching assist tool to the parking brake control assembly.

8. The calibrated adjustable-configuration parking brake stretching assist tool of claim 2, wherein the actuation detection unit outputs the indication that the parking brake control assembly is depressed by the defined depression amount such that a secondary indication that the parking brake control assembly is depressed by the defined depression amount is presented.

9. The calibrated adjustable-configuration parking brake stretching assist tool of claim 2, wherein the actuation detection unit outputs the indication that the parking brake control assembly is depressed by the defined depression amount by transmitting a signal to a receiving device.

10. A method for stretching a parking brake cable, the method comprising:
engaging at least a portion of a parking brake control assembly of a vehicle with a calibrated adjustable-configuration parking brake stretching assist tool in a neutral position, wherein the parking brake control assembly includes a parking brake cable, and wherein the calibrated adjustable-configuration parking brake stretching assist tool includes:
a handle;
a parking brake control assembly engagement portion attached to a first end of the handle, such that the handle extends along an axis to a second end of the handle; and
an actuation control portion, laterally attached to the calibrated adjustable-configuration parking brake stretching assist tool proximate to the first end of the handle; and
applying a force to the handle such that the actuation control portion contacts a fixed surface of the vehicle indicating that the portion of the parking brake control assembly is depressed by a defined depression amount.

11. The method of claim 10, wherein the actuation control portion includes an actuation detection unit, and wherein, applying the force includes applying the force such that in response to detecting that the parking brake control assembly is depressed by the defined depression amount, the actuation detection unit outputs an indication that the parking brake control assembly is depressed by the defined depression amount.

12. The method of claim 11, wherein the actuation control portion has a defined length of longitudinal extension from the first end of the handle.

13. The method of claim 12, wherein the defined length of the actuation control portion is adjustable, and wherein the method includes:
adjusting the actuation control portion such that the actuation control portion is extended to an adjusted length to engage the fixed portion of the vehicle on a condition that the parking brake control assembly is depressed by the defined depression amount.

14. The method of claim 13, wherein the defined depression amount is full pedal stroke.

15. The method of claim 13, wherein the defined depression amount is at least three-quarters full pedal stroke.

16. The method of claim 13, wherein the calibrated adjustable-configuration parking brake stretching assist tool includes:
a support bar attached to the parking brake control assembly engagement portion, and extending laterally therefrom; and
a parking brake control arm engagement portion attached to the support bar, such that, in response to applying the force to the handle, the force is applied to a proximal surface of the parking brake control assembly in a first direction and is rotationally translated to the parking brake control arm engagement portion, such that the parking brake control arm engagement portion applies a corresponding force to a distal surface of the parking brake control arm in a second direction opposite the first direction to secure the calibrated adjustable-configuration parking brake stretching assist tool to the parking brake control assembly.

17. The method of claim 10, applying the force includes:
applying the force for a defined stretching period; and
discontinuing applying the force in response to the defined stretching period elapsing.

18. A calibrated adjustable-configuration parking brake stretching assist tool comprising:
a handle;
a brake pedal engagement portion attached to a first end of the handle, such that the handle extends along an axis to a second end of the handle, the brake pedal engagement portion for depressing a parking brake control assembly of a vehicle in response to a force applied to the second end of the handle; and
an actuation control portion, laterally attached to the calibrated adjustable-configuration parking brake stretching assist tool proximate to the first end of the handle, for engaging a fixed portion of the vehicle adjacent to the parking brake control assembly on a condition that the parking brake control assembly is depressed by a defined depression amount, wherein the actuation control portion includes an actuation detection unit, and wherein, in response to detecting that the parking brake control assembly is depressed by the defined depression amount, the actuation detection unit outputs an indication that the parking brake control assembly is depressed by the defined depression amount.

19. The calibrated adjustable-configuration parking brake stretching assist tool of claim 18, wherein the actuation control portion has a defined length of longitudinal extension from the first end of the handle, and wherein:
the defined length of the actuation control portion is adjustable; and
the actuation control portion is extended to an adjusted length to engage the fixed portion of the vehicle.

20. The calibrated adjustable-configuration parking brake stretching assist tool of claim 18, further comprising a communication unit configured to transmit a signal to a receiving device in response to the indication that the parking brake control assembly is depressed by the defined depression amount output by the actuation detection unit.
